(19) United States
(12) Patent Application Publication
(10) Pub. No.: US 2015/0186457 A1
(43) Pub. Date: Jul. 2, 2015

(54) SIMILAR ASSEMBLY-MODEL STRUCTURE SEARCH SYSTEM AND SIMILAR ASSEMBLY-MODEL STRUCTURE SEARCH METHOD

(71) Applicant: HITACHI, LTD., Tokyo (JP)

(72) Inventors: Atsuko Enomoto, Tokyo (JP); Noriaki Yamamoto, Tokyo (JP); Yumiko Ueno, Tokyo (JP)

(21) Appl. No.: 14/405,843

(22) PCT Filed: May 28, 2013
(86) PCT No.: PCT/JP2013/064710

§ 371 Date: Dec. 5, 2014

(30) Foreign Application Priority Data
Jun. 5, 2012 (JP) 2012-128264

(51) Int. Cl. G06F 17/30; G06F 17/50

(52) U.S. Cl. CPC G06F 17/30424; G06F 17/50

(57) ABSTRACT

Provided is a technology for efficiently extracting from sub-assemblies designed in the past a sub-assembly similar to a newly designed sub-assembly. A system is adopted where information about an assembly model created by 3D-CAD is stored in a database, and an assembly portion to be searched for is also input as a 3D assembly model. A feature value and shape similarity of components of a sub-assembly as the object of search, and the degree of partial correspondence in adjacency relationship of the components are determined, and the similar sub-assembly is extracted from the entire assembly model. By a search system such that a component requiring shape similarity consideration and a component not requiring shape similarity consideration are mixed and the similarity of the adjacency relationship of the components is inquired, the entire assembly model is searched for a sub-assembly portion similar to a predetermined sub-assembly. Further, in an assembly structure search, constituent components that are partially different in configuration and that do not completely correspond are also searched, and the degree of correspondence is presented quantitatively.

### TECHNICAL FIELD

The present invention relates to assembly model similar structure search systems, and assembly model similar structure search methods.

### BACKGROUND ART

Currently, design supporting search involves registering individual components (registration of defective components) and conducting a search. Design specifications and attribute values of shapes are registered on a component by component basis, and a search is conducted using such information as a search key. One example of such component-based search method is described in Non Patent Literature 1, for example.

### CITATION LIST

### Patent Literature

Patent Literature 1: JP 2011-248622 A

### Non Patent Literature

Non Patent Literature 1: Hideki NAGAYA, Kaoru KATAYAMA, and Hiroshi ISHIKAWA: “Application of Cauchy's Interlace Theorem to Subgraph Isomorphism Detection for Large Graphs”, Tokyo Metropolitan University, DEW2006 3B-i9

### SUMMARY OF INVENTION

### Technical Problem

However, the method described in Non Patent Literature 1 is still not capable of enabling unified management for storage and search of design or manufacturing information relating to a plurality of components constituting an assembled item. When a case search (search for defective cases) is conducted on a component by component basis, the search results would be too numerous if the search is done on a sub-assembly unit basis. As a result, much time and effort would be required to find a target set of components from the search results, lowering the efficiency of sub-assembly verification. Thus, in order to efficiently verify whether the probability of the presence of a defect in a newly designed sub-assembly is high, it is preferable if the defect information about a similar sub-assembly that has been designed in the past could be utilized. For that purpose, a mechanism for a search of similar sub-assemblies is required.

When a manufacturing process for a newly set sub-assembly is to be determined, efficiency can be greatly improved if the manufacturing process for the similar sub-assembly, if any, that has been designed in the past is available for reuse.

Further, in the case of an assembled item, there are attribute values arising from a plurality of attribute values across a plurality of components and from the adjacency relationship of the components, and currently there is no index as to on what basis correspondence with the original assembled item for which the search is conducted can be determined. Thus, it is not often the case that complete matches with respect to all keys are achieved in a search, and it is also difficult to search for a partially similar object item that the user may desire.

The present invention was made in view of such circumstances, and provides a technology for efficiently extracting, from sub-assemblies that have been designed in the past, a sub-assembly similar to a newly designed sub-assembly.

### Solution to Problem

In order to solve the problem, the present invention realizes an assembled item database system capable of storing and searching design or manufacturing information. A database adopts a system such that information about an assembly model created by 3D-CAD is stored, and an assembly portion to be searched for is also input as a 3D assembly model. Feature values and shape similarity of components of a sub-assembly as the object of search, and the degree of partial correspondence in adjacency relationship of the components are determined, and a similar sub-assembly is extracted from the entire assembly model. By a search system in which a component requiring shape similarity consideration and a component not requiring shape similarity consideration are mixed, and in which the similarity of adjacency relationship of the components is inquired, the entire assembly model is searched for a sub-assembly portion similar to a predetermined sub-assembly. Further, in an assembly structure search, constituent components that are partially different in configuration and that do not completely correspond are also searched, and the degree of correspondence is presented quantitatively.

According to the present invention, a similar structure search database is provided in which at least a part attribute value indicating an attribute value of a component of an assembly, and information about a geometric constraint relationship indicating a connection relationship between components are retained. A similar shape search section is configured to compare, with reference to the similar structure search database, the part attribute value and the geometric constraint relationship of a search source assembly and a search object assembly which are designated by a user, so as to identify, in the search object assembly, a component similar to the constituent component of the search source assembly and a geometric constraint relationship similar to the geometric constraint relationship of the search source assembly. A similar structure search section, based on information about the similar component and the geometric constraint relationship identified by the similar shape search section, is configured to determine whether a structure of the search source assembly is included. An output section is configured to output a result of determination by the similar structure search section as a search result.

### Advantageous Effects of Invention

According to the present invention, a sub-assembly similar to a newly designed sub-assembly can be efficiently extracted from among sub-assemblies that have been designed in the past.

Additional features of the present invention will become apparent from the following description of the present specification and attach drawings. Aspects of the present invention may be achieved or realized by various elements or combinations of elements, and by the following detailed description and the aspects of the scope of the appended claims.

It should be understood that the description in the present specification provide merely typical examples and do not in any way limit the scope of the claims of the present invention or application examples thereof.

### BRIEF DESCRIPTION OF DRAWINGS

FIG. 1 illustrates a configuration of a similar structure search system and an assembly search system including a 3D-CAD system according to an embodiment of the present invention.

FIG. 2 is a flowchart for describing a similar structure search process according to a first embodiment of the present invention.

FIG. 3 illustrates a search condition input procedure (GUI) according to the first embodiment of the present invention.

FIG. 4 illustrates a graph representation of an example of the similar structure search process according to the first embodiment of the present invention.

FIG. 5 illustrates an example of a search result output (GUI) according to the first embodiment of the present invention.

FIG. 6 is a flowchart for describing the similar structure search process according to a second embodiment of the present invention.

FIG. 7 illustrates a graph representation of an example of the similar structure search process according to the second embodiment of the present invention.

FIG. 8 illustrates an example of a search condition table and a search result output (GUI) according to a third embodiment of the present invention.

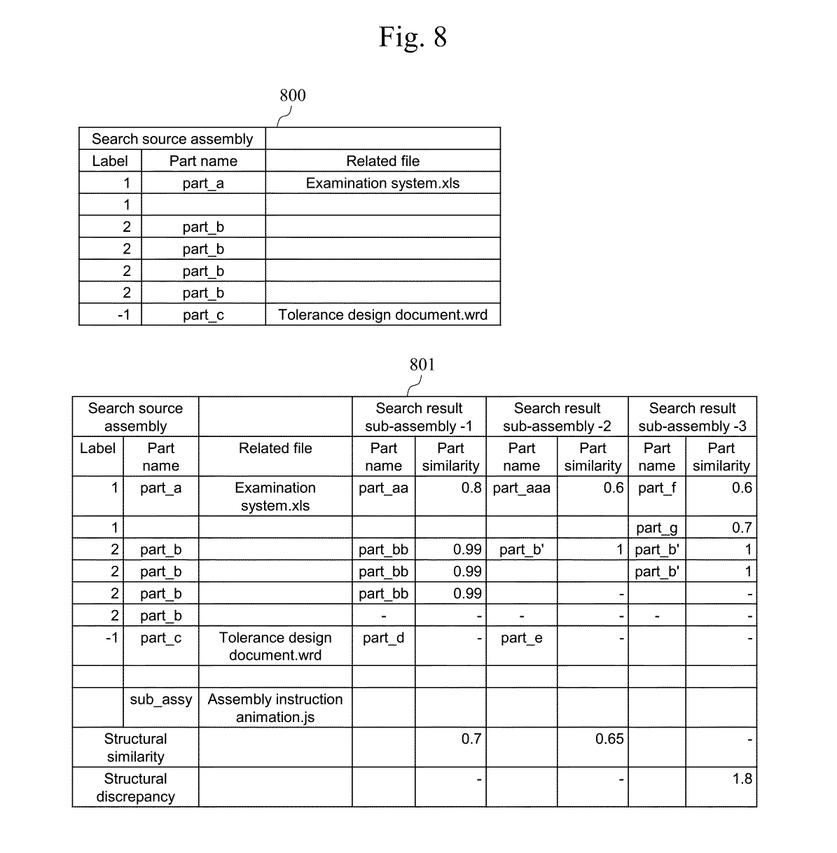

### DESCRIPTION OF EMBODIMENTS

The present invention relates to, for example, case classification and search for assembled item quality management, process classification in a process planning for assembled item manufacturing, and standardization for assembled item designing.

In the following, embodiments of the present invention will be described with reference to the drawings. In the attached drawing, functionally identical elements may be designated with identical numerals. The attached drawings illustrate concrete embodiments and implementation examples in accordance with the principle of the present invention. The embodiments and implementation examples are merely for aiding understanding of the present invention, and are not to be used for interpreting the present invention in a limiting sense.

While the embodiments will be described in such sufficient details that one skilled in the art can implement the present invention, it should be understood that other implementations or modes are possible, and that various modifications of configurations or structures or substitution of various elements may be made without departing from the technical scope and spirit of the present invention. Thus, the following description should not be interpreted as limiting the present invention.

### (1) First Embodiment

### Configuration of Similar Structure Search System

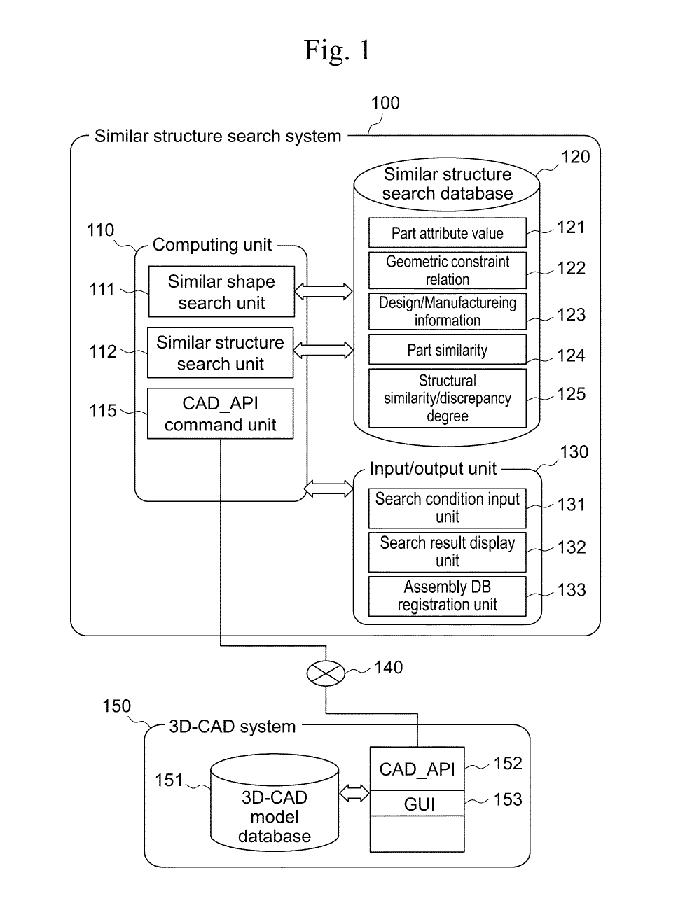

FIG. 1 schematically illustrates the configuration of a similar structure search system and an assembly search system including a 3D-CAD system according to the present invention.

The similar structure search system 100 according to the present embodiment of the invention includes a computing unit 110, a similar structure search database 120, and an input/output unit 130, which are connected to the 3D-CAD system 150 via a network 140. The 3D-CAD system 150 includes a 3D-CAD model database 151 in which a registered 3D assembly model is stored.

The computing unit 110 includes a similar shape search unit 111 that searches for a component similar in shape to a component (part); a similar structure search unit 112 that searches for a sub-assembly similar to a search object assembly (newly designed assembly) using a search source assembly (registered assembly: an assembly that has been designed in the past) as a query (determining whether a similar structure is included); and a CAD_API command unit 115 that acquires the search source assembly from the 3D-CAD model database 151 in accordance with an instruction from a user. The various processing units of the computing unit 110 may be realized by a processor operating a program for executing the various processes.

The similar structure search database 120 includes a part attribute value 121 for storing an attribute value of a component (part); a geometric constraint relationship between components (information indicating via which faces components are joined) 122; design/manufacturing information 123 including information about a sub-assembly defect or manufacturing process; part similarity 124 which is information about component similarity; and a structural similarity/discrepancy degree 125 which is information about a structural similarity/discrepancy degree with respect to each sub-assembly. The part similarity is computed information indicating what degree of similarity there is between a newly created component and a component registered in the database in the past. A computing method is described in Patent Literature 1.

The input/output unit 130 includes a search condition input unit 131 that the user uses when designating an assembly as a search source (a past assembly that is already registered), and when an assembly as a search object (newly designed assembly); a search result display unit 132 that displays a search result; and an assembly DB registration unit 133 that issues a command via the CAD_API command unit 115 to a CAD_API of the 3D-CAD system 150 to acquire data necessary for similar structure analysis of a plurality of assemblies models designated by the user. The data necessary for the similar structure analysis includes the part attribute value 121 and the geometric constraint relationship 122. The part attribute value 121 includes, for example, mass property (principal axis of inertia moment, mass, center of gravity position), surface area, volume, bounding box dimensions (outer shape dimensions comprising length, width, and height), component name, component type, component number, and dimensional tolerance (which may include type of dimension). The geometric constraint relationship 122 includes information about the presence or absence of geometric constraint between components, type of geometric constraint surfaces between components, and geometric tolerance. The assembly DB registration unit 133 associates the design or manufacturing information 123 with a registered assembly or part as designated by the user.

### <Content of Search Process>

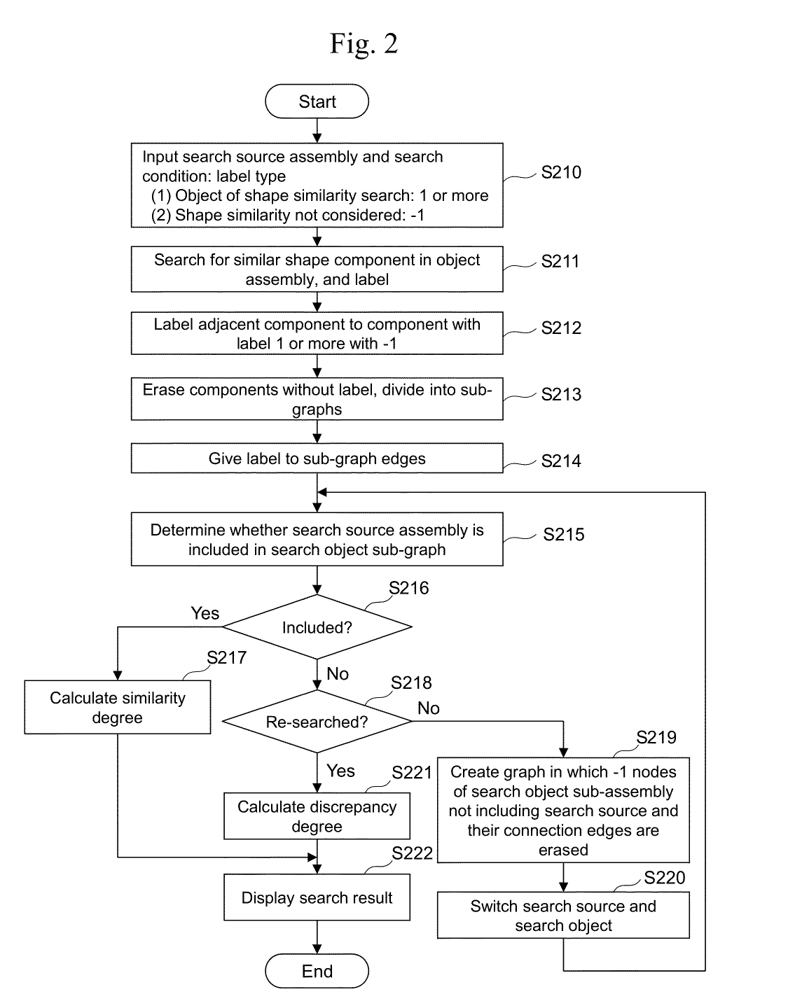

FIG. 2 is a flowchart for describing a sub-assembly search process according to the first embodiment.

### (i) Step 210

The search condition input unit 131, in response to a user instruction, registers an assembly model as a search source in the similar structure search database 120. Specifically, when the user designates a search source assembly using the search condition input unit 131, a command is issued via the CAD_API command unit 115 to the CAD_API of the 3D-CAD system 150, and then the assembly model designated by the user is acquired and registered in the similar structure search database 120. With regard to the registered search source assembly, the search condition input unit 131 registers a label (node label) designated by the user in the part attribute value 121 of each part. With regard to the node label, the user sets a value for the part for which a similar shape is desired to be searched for. If there is a plurality of parts in the search source assembly that the user considers to have a similar shape, these parts are given the same label (node label) value. A part that the user desires to search for even if it has a different part shape (i.e., regardless of similarity in shape) is given a label “−1”, which indicates a node label that makes no distinction about shape similarity.

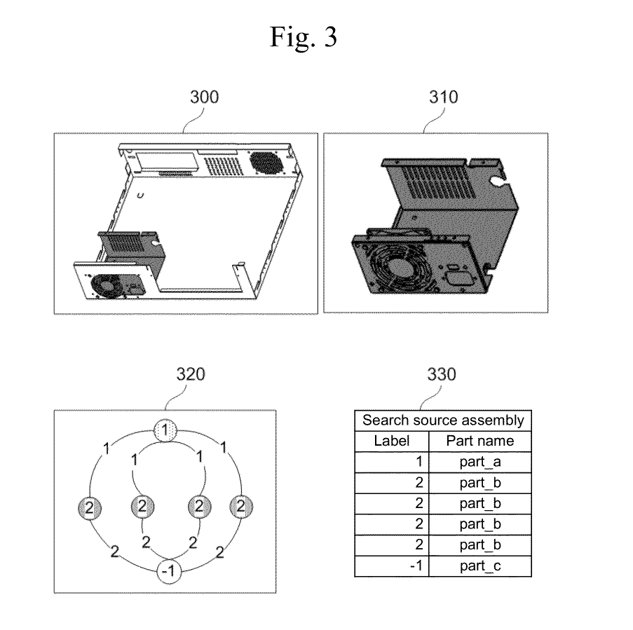

In step 210, the CAD_API command unit 115 causes, via the CAD_API 152, the GUI 153 of the CAD to prompt the user to select a search object assembly or a similarity search object part (see 300 in FIG. 3). Also in step 210, the selected search source assembly is displayed (310 in FIG. 3) and its graph 320 is displayed to the user.

Further, in step 210, the label of the similarity search source part input by the user, nodes of the graph 320, and a table 330 are displayed.

In the search source assembly, the geometric constraint relationship between the nodes is labeled as edge labels. The geometric constraint relationship includes, for example, a planar constraint and a cylindrical constraint, the former being given label 1 and the latter being given label 2.

### (ii) Step 211

The similar shape search unit 111, with respect to the search object assembly, labels parts having shapes similar to those of the labeled parts of the search source assembly, as illustrated in a graph 401. Namely, the similar shape search unit 111, with respect to the parts constituting the search object assembly designated by the user, searches for parts with similar shapes by comparison of the part attribute value 121 in the similar structure search database 120. Text information such as the component name or type is expressed by numerical values in advance by using the Levenshtein distance, for example.

The method of search for the similar shape parts will be described. Herein, the part attribute value will be referred to as a feature vector of k-dimension vector. The feature vector of the search source part is designated by a, and the part as the search object is designated by x. The difference between x and a is evaluated according to the following expression 1.

$$a = ( \begin{matrix}{p}_{1} & {p}_{2} & … & {p}_{k}\end{matrix} ) \\ x = ( \begin{matrix}{q}_{1} & {q}_{2} & … & {q}_{k}\end{matrix} ) \\ d = \frac{( x - a ) \cdot a}{a \cdot a} \qquad ( Expression 1 )$$

The difference between the search source part and the search object part is expressed by d in expression 1. When d=0.0, a=x, so that the feature quantities are the same. It is determined that the greater the |d|, the more greatly the part x differs from the part a. An upper limit value of the feature quantity difference is designated as dmax. The part x that satisfies expression 2 is determined to be similar to the search source part a.

|d|≦dmax (Expression 2)

The feature quantity is divided into a plurality of vectors with significance. When there are n feature quantity vectors, similarity determination is performed according to the following expression 3.

$${a}_{i} = ( \begin{matrix}{p}_{i 1} & {p}_{i 2} & … & {p}_{ik}\end{matrix} ) \\ {x}_{i} = ( \begin{matrix}{q}_{i 1} & {q}_{i 2} & … & {q}_{ik}\end{matrix} ) \\ {d}_{i} = \frac{( {x}_{i} - {a}_{i} ) \cdot {a}_{i}}{{a}_{i} \cdot {a}_{i}} \\ dav = ( {d}_{1} + … + {d}_{n} ) / n \\ \vert dav \vert \leq d max \qquad ( Expression 3 )$$

As regards the material of the parts, the determinations of expression 2 and 3 are made by using the composition amounts of the contained components as the components of the feature quantity vectors a and x of expression 1.

For the parts determined to be similar by the above process, the same label (node label) as that of the search source part is given to the search object part.

(iii) Step 212

The similar shape search unit 111, with respect to the search object assembly, gives the label (node label) “−1.” to the part having a geometric constraint relationship with a part with the label (node label) of 1 or more (212). The node label “−1” indicates that a part that makes no shape distinction is connected. The individual parts are connected by a relationship indicated by an edge label as will be described later.

In the search object assembly, the node label “−1” may be provided to only a component (search object component) adjacent to a component equivalent to the node label of a component with the node label “1” or more which is adjacent to a component with the node label “−1” in the search source assembly, and other nodes may not be given any labels.

### (iv) Step 213

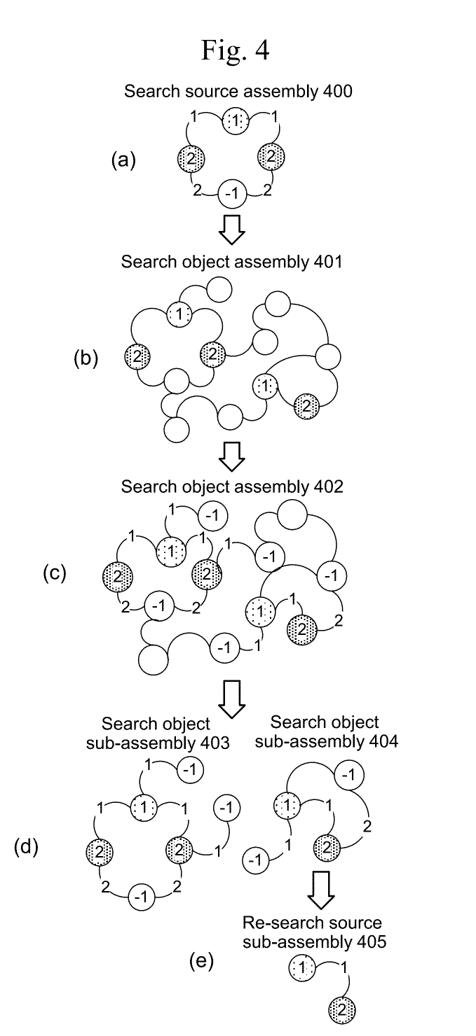

The similar shape search unit 111, with respect to the search object assembly, erases parts corresponding to nodes without labels, and divides the assembly into link graphs (sub-graphs). Thus, the search object assembly is divided into a plurality of sub-graphs. A search object assembly 401 which will be described below (see FIG. 4) is divided into two sub-graphs of search object sub-assemblies 403 and 404.

### (v) Step 214

The similar shape search unit 111 gives labels (edge labels) to the search object sub-graphs in accordance with the type of geometric constraint. As described above, the edge labels include the planar constraint “1” and the cylindrical constraint “2”. The edge label information is information about inter-component relationship, and is acquired from the 3D-CAD system 150.

### (vi) Step 215

In step 215, a similar structure search process is executed. Specifically, the similar structure search unit 112, for those of a plurality of search object assembly parts that are given node labels, forms a graph having the parts as nodes and edges corresponding to geometric restrictions, if any. At this time, the label values of the edges of the graph are classified according to the type of the geometric restriction.

The similar structure search unit 112, with respect to the search object sub-graphs, creates a diagonal matrix Lv having the node labels as diagonal components, a diagonal matrix Le having the edge labels as diagonal components, and, when an edge is present between two nodes, an incidence matrix H where 1 is given to the components having the node number as a row number and an edge number as a column number. These three matrices are combined into a matrix according to expression 4, where a matrix is created in which the rows having −1 as the component value are deleted and is substituted for the matrix G. In the following description, the matrix G refers to the matrix G according to expression 4 from which the rows having −1 as the component value are deleted.

$$G = [ \begin{matrix}{L}_{v} & H \\ {H}^{T} & {L}_{e}\end{matrix} ] \qquad ( Expression 4 )$$

The similar structure search unit 112 further creates the matrix G with respect to the search source graph and the divided sub-graphs of the search object, and determines an eigen value column. When the eigen value column of the search source graph is μ and the eigen value column of the divided sub-graphs of the search object is λ, if the relationship of the Interlace theorem according to expression 5 is satisfied, there is the possibility that the search object sub-graph is included in the search source graph.

Eigen values of Gₐ:λ=[λ₁ . . . λₙ]

Eigen values of G_{b}:μ=[μ₁ . . . μₘ] (m≦n)

G_{b}⊂Gₐ

[symbol]

for ∀i≦m, λᵢ≦μᵢ≦λᵢ₊ₙ₋ₘ (Expression 5)

(vii) Step 216

The similar structure search unit 112 determines that, if expression 5 is satisfied, the search object sub-graph is included in the search source graph, and that the sub-assembly corresponding to the search object sub-graph is similar to the search source assembly of the search source graph. If included, the process proceeds to step 217; if not included, the process proceeds to S218.

(viii) Step 217

When expression 5 is satisfied, the similar shape search unit 111 calculates how the two sub-assemblies are similar according to expression 6.

initial condition:δ=0

for i=1 to m

δ=δ+(μᵢ−λᵢ)/(λₙ₋ₘ₊ᵢ−λᵢ) (Expression 6)

### (ix) Step 218

The similar structure search unit 112 determines whether a search process has been executed using, as a query, the sub-graph of the search object that has been determined to be not included. If the search process has been performed, the process proceeds to step 221; if the search process has not been executed, the process proceeds to step 219.

### (x) Step 219

The similar structure search unit 111 creates, from the relevant sub-graph of the divided search object sub-assembly, a graph from which the nodes given the label “−1” and the edge labels connected to the nodes are deleted.

### (xi) Step 220

The similar structure search unit 112 creates a matrix of the graph created in step 219 according to expression 4, and sets the sub-assembly of the graph as a re-search source assembly (query) and the initial search source graph as a re-search object assembly. Then, a search process is again executed using the new query as according to the process of step 215. If the result satisfies expression 5, the re-search source sub-assembly, because it is included in the re-search object assembly, is determined to be a similar structure, and the similarity is computed in step 217.

(xii) Step 221

If expression 5 is not satisfied even by the re-search process, it is determined that the sub-assembly is not a similar structure, and its discrepancy degree is computed according to expression 7.

| | |
|---|---|
| initial condition : δ = 0 | ... (Expression 7) |
| for i = 1 to m | |

if μᵢ − λi <0 then δ = δ−(μᵢ − λᵢ)/(λₙ₋ₘ₊ᵢ − λᵢ)

else if λₙ₋ₘ₊ᵢ − μᵢ < 0 then δ = δ − (λₙ₋ₘ₊ᵢ −
μᵢ)/(λₙ₋ₘ₊ᵢ − λᵢ)

end

end

(xiii) Step 222

The search result display unit 132 presents the user with the similar assembly in the form of 310 in FIG. 3 as a search result obtained by the above process, and presents the user with a similar assembly graph in the form of 320.

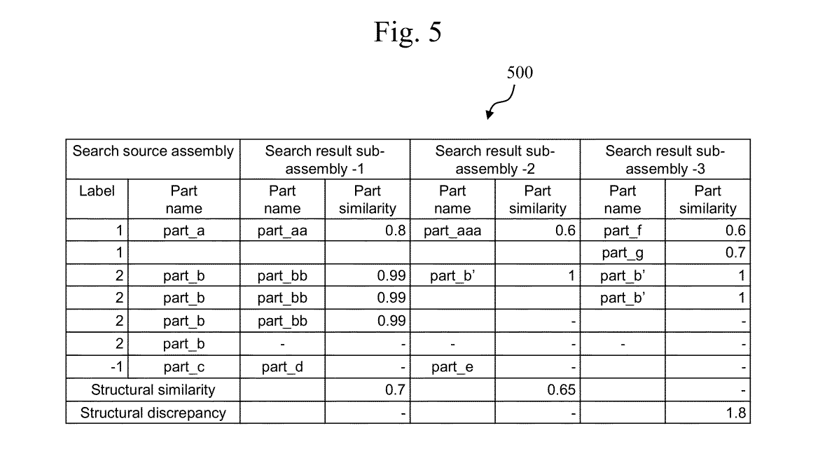

Further, the search result display unit 132 displays, in a search result display GUI shown in FIG. 5, the search source assembly and the similar sub-assembly of the search result. Specifically, the user is presented with the constituent parts and node labels of the search source assembly; the constituent part name of the similar sub-assembly model of the search result and the part similarity with the search source part of the identical node label; the computed result of the structural similarity in the case where the structure is similar; and the computed result of the structural discrepancy degree in the case where the structure is divergent. In FIG. 5, because the similar sub-assemblies 1 and 2 in the search result are determined to have an inclusive relation with the search object assembly, only the structural similarity is computed. With regard to the sub-assembly 3 in the search result, because the sub-assembly 3 is determined to not have an inclusive relation, i.e., to be not similar, only the structural discrepancy degree is computed.

### <Concrete Examples of Search Process>

FIG. 4 illustrates a concrete example of the search process illustrated in FIG. 2.

The user designates a search source assembly 400, and inputs a node label and an edge label of each part (see FIG. 4(a)). It is assumed that, in the search source assembly graph 400, the user is wishing to search for a sub-assembly having one part similar to the part of label 1, two parts similar to the parts with label 2, and one part that makes no shape distinction, with the geometric constraint illustrated in graph 400. The search source assembly 400 may include an assembly that had a defect in the past or an assembly of which the manufacturing process is registered, and it is determined whether a part of the assembly is included in the newly designed assembly (search object assembly 401).

In the search object assembly 401, parts similar to the parts of the search source assembly are given the node labels given to the search source assembly (see FIG. 4(b)).

Next, the search object assembly 401 with the given node labels are given edge labels indicating the geometric constraint relationship between the nodes, generating a search object assembly 402 with the given node and edge labels (see FIG. 4(c)).

Then, in the search object assembly, parts to which no node labels are given are erased, and the link graph of the search object assembly 402 is divided into sub-graphs, generating two search object sub-assemblies 403 and 404.

Thereafter, it is determined whether each of the search object sub-assemblies includes the search source assembly 400. In the example of FIG. 4, the sub-assembly 403 includes the search source assembly 400 but the sub-assembly 404 does not include the search source assembly 400. Thus, similarity is computed with respect to the sub-assembly 403.

Further, in the divided search object sub-assembly 404, a sub-assembly graph 405 is created in which the nodes with the node label “−1” and edges connected to the nodes are deleted. The sub-assembly 405 is used as a re-search source, while the original search source assembly 400 is used as a re-search object assembly. Namely, a re-search process is executed by switching the search source and the search object. If the result of this search process satisfies the above expression 5, the re-search source sub-assembly 405 is included in the re-search object assembly 400. Thus, the re-search source sub-assembly 405 is determined to be a similar structure, and similarity is calculated therefor. If it is determined that there is no inclusive relation even after the re-search process, discrepancy degree is computed.

The search result display unit 132 displays the design/manufacturing information file 123 relating to the search source parts registered in the similar structure search database 120 by the search condition input unit 131 or to the search source assembly in the form of a table 801.

For example, a part_a is associated with a component examination method document, a part_c is associated with a tolerance design document, and the search source sub-assembly itself is associated with an assembly work instruction animation. The table 801 means that a part_aa or a part_f can be examined using the examination system document (examination system.xls). It is also seen that the tolerance of a part_d or a part_e can be checked using the tolerance design document (tolerance design document.wrd). It is further seen that the search source assembly instruction animation can be referred to when formulating an assembly procedure for each search object assembly.

### (2) Second Embodiment

When a manufacturing process is actually extracted, a similar assembly can be more efficiently extracted by searching for the inclusive relation of assemblies by considering not just the assembly of interest but also the relationship with other parts connected to the assembly.

Thus, the second embodiment is directed to a search execution process such that, in the similar structure search unit 112 of the first embodiment, all of the paths that go through a number of edges designated by the user from the nodes with labels are searched for, and the graph is extended by the nodes and edges included in the paths. Namely, the user is enabled to designate how many of the parts connected to the assembly of interest are to be considered (when the number of additionally adjacent parts is two, the order of expansion is 2).

### <Content of Search Process>

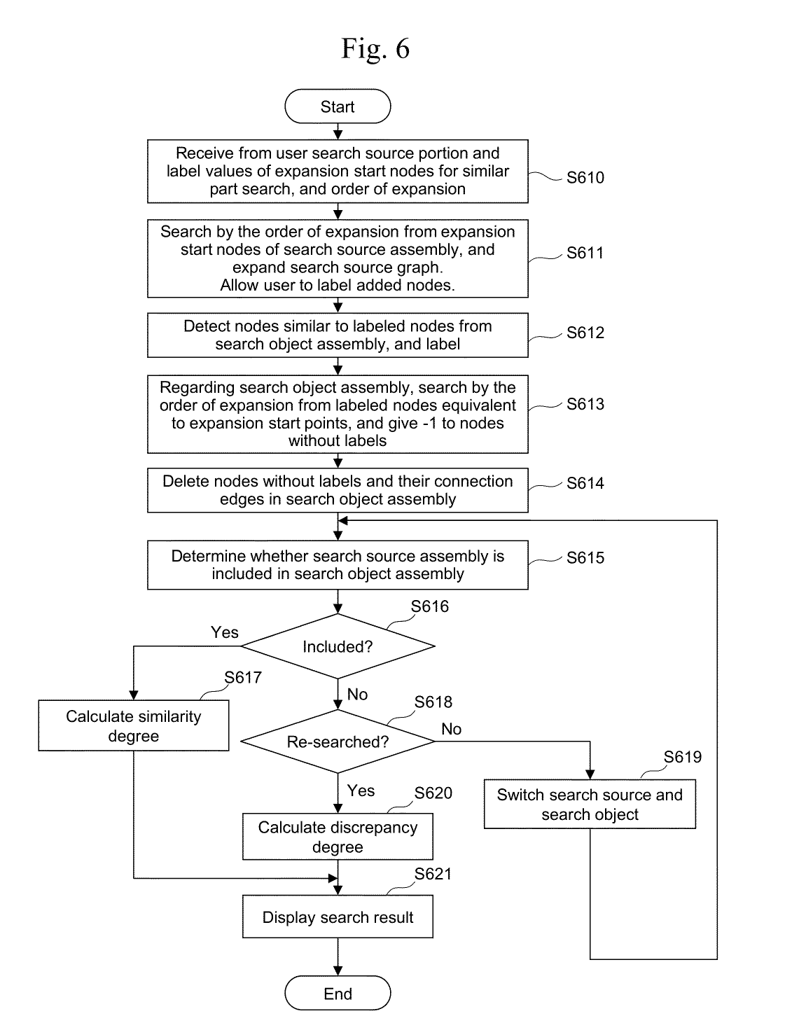

FIG. 6 is a flowchart for describing the search process according to the second embodiment.

### (i) Step 610

The search condition input unit 131 receives an input from the user including a search source assembly; node label values of nodes as the object for similar part search, and the edge label values between the nodes; and a starting point node for expansion and the order of expansion (a value (order of expansion) as to how many adjacent parts are to be added to the search source assembly to provide a search source). The search condition input unit 131 also receives a search object assembly designated by the user (such as a newly designed assembly).

For example, when the search source portion is a hose, there may be a number of portions connected to the hose. Thus, by the order of expansion, other portions connected to the hose (such as the engine and fuel; in this case, the order of expansion is 2) are included in the search source assembly.

### (ii) Step 611

The similar shape search unit 111 searches for the nodes corresponding to the input order of expansion from the designated expansion starting point nodes of the search source assembly, and expands the search source assembly graph. The expanded search source assembly graph is presented (displayed) to the user, and the search condition input unit 131 receives the label values of the expanded/added nodes input from the user. The similar shape search unit 111 labels the input label values to the expansion nodes.

(iii) Step 612

The similar shape search unit 111 detects in the search object assembly nodes (parts) similar to the label nodes of the search source assembly, and gives the same label values to the similar nodes, if any.

### (iv) Step 613

The similar structure search unit 112 searches for the nodes corresponding to the order of expansion from the nodes as the starting points of expansion of the search object assembly, and gives −1 if the nodes have no labels.

### (v) Step 614

The similar structure search unit 112 deletes the nodes to which no label values are given in the search object assembly and the edges connected to the nodes without labels.

### (vi) Step 615

The structure similarity search unit 112, as in the first embodiment, determines whether the expanded search source assembly is included in the search object assembly.

(vii) Step 616

If the expanded search source assembly is included in the search object assembly, the process proceeds to step 617; if not included, the process proceeds to step 618.

(viii) Step 617

The structure similarity search unit 112 computes a similarity degree by the same process as in the first embodiment.

### (ix) Step 618

The similar structure search unit 112 determines whether a search process has been executed using, as a query, the graph of the search object assembly determined to be not included. If the search process has been executed, the process proceeds to step 620; if the search process has not been executed, the process proceeds to step 619.

### (x) Step 619

The similar structure search unit 112 switches the search source assembly and the search object assembly. The process then proceeds to step 615, and the similar structure search unit 112, using the current search object assembly as a query, determines the inclusive relation again to see if the current search object is included in the search source assembly.

### (xi) Step 620

The similar structure search unit 112 computes the degree of discrepancy by the same process as in the first embodiment.

(xii) Step 621

The search result display unit 132 displays the search result obtained by the above process by the same process as in the first embodiment.

### <Concrete Example of Search Process>

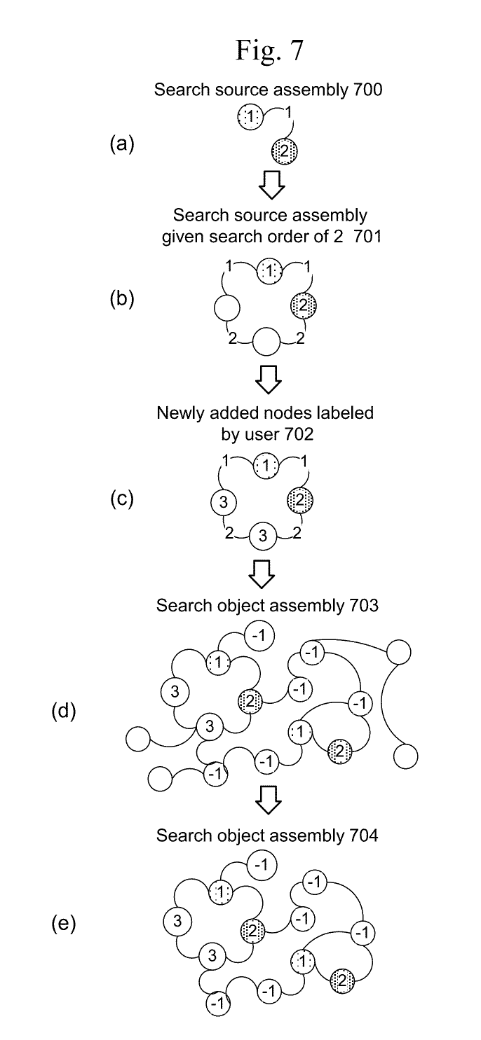

FIG. 7 illustrates a concrete example of the search process according to the second embodiment.

With respect to a search source assembly 700 designated by the user, first the label values input by the user are given to the respective nodes and edges (see FIG. 7(a)).

The search source assembly is searched for all of the paths going from the expansion starting point nodes through the edges of the order of expansion designated by the user, and the graph is expanded by the nodes and edges included in the paths. Thus, an expanded search source assembly 701 (see FIG. 7(b)) is generated. At this time, no label values are given to the expanded nodes.

The user is presented with the nodes newly added by the search source assembly graph expansion, and the user inputs labels, whereby a search source assembly given the expansion node labels is generated (see FIG. 7(c)).

Next, the search object assembly designated by the user is searched for nodes similar to the labeled nodes of the search source assembly, and label values are given. Those of the nodes in the search source graph (a) separated from the expansion starting point nodes (1 and 2 in (a)) by the order of expansion that are not given labels are given the label −1, generating a node label-attached search object assembly 703 (see FIG. 7(d)).

Thereafter, from the node label-attached search object assembly 703, nodes that are not given label values and edges connected to the nodes are deleted, generating a search object assembly 704 as the object of inclusive relation determination (see FIG. 7(e)).

Between the search source assembly 702 and the search object assembly 704 obtained as described above, inclusive relation is determined. Thereafter, the process of each step described with reference to FIG. 6 is executed, and a search result is presented to the user.

### (3) Conclusion

(i) According to the present invention, when conducting case classification or a search for assembled item quality management, process classification for assembled item manufacturing process planning, or standardization for assembled item design, a search between 3D assembly models can be conducted using a 3D assembly model that is desired to be searched for as a search source with respect to a database in which a 3D assembly model is registered. When the registered 3D model is linked to quality management, process design, design specifications and the like, product or manufacturing information can be easily retrieved from the 3D model and reutilized. Further, when an assembly is registered as an entire assembly, the portion of a sub-assembly satisfying a predetermined similarity can be automatically extracted from the entire assembly. Thus, the assembly model can be automatically registered in the database by a script, reducing the time and effort for database management.
(ii) More specifically, according to the present invention, the part attribute values and geometric constraint relationship of the search source assembly designated by the user (assembly that has been designed in the past) and the search object assembly (newly designed assembly) are compared. The comparison identifies, in the search object assembly, a component similar to a constituent component of the search source assembly, and a geometric constraint relationship similar to a geometric constraint relationship of the search source assembly. Based on the information about the identified similar component and geometric constraint relationship, it is determined whether the search object assembly includes the structure of the search source assembly. The result of determination is output (displayed) as a search result. In this way, a past assembly similar to the newly designed assembly can be searched for. From the past assembly defect information, a defect that tends to be caused in the newly designed assembly may be identified or verified, and further the information about the past assembly manufacturing process can be recycled for the newly designed assembly. Accordingly, assembly design or manufacturing management can be easily and efficiently performed.

If the newly designed assembly (search object assembly) includes a plurality of sub-assembly portions including components similar to constituent components of the assembly designed in the past (search source assembly), the search object assembly may include a first type sub-assembly portion including the search source assembly and a second type sub-assembly portion not including the search source assembly. Thus, the present invention distinguishes these assembly portions, and sets the second type sub-assembly portion as a re-search source assembly and the search source assembly as a re-search object assembly. Namely, the search object and the search source are switched. Then, it is determined again whether the re-search source assembly is included in the re-search object assembly. The determination result is included in the initial search result when presented to the user. In this way, a past assembly similar to the newly designed assembly can be reliably acquired.

With regard to the search object assembly that includes the search source assembly, similarity between the assemblies is computed and included in the search result. With regard to the search object assembly that does not include the search source assembly, the discrepancy degree between the assemblies is computed and included in the search result. Thus, information about how similar the new design assembly and the past design assembly are to each other, or how different they are from each other, can be presented to the user. Based on the information, the user can perform new assembly verification efficiently.

(iii) In the second embodiment, the search process is executed by expanding the components connected to the search object assembly (search portion). The information indicating the degree of expansion of the components is the search order (node order of expansion), which is designated by the user. In accordance with the search order, constituent components of the search source assembly are added to generate an expanded search source assembly. Then, the part attribute values and geometric constraint relationships of the expanded search source assembly and the search object assembly are compared. Based on the result of the comparison, in the search object assembly, a component similar to a constituent component of the expanded search source assembly and a geometric constraint relationship similar to a geometric constraint relationship of the expanded search source assembly are identified. Further, based on the information about the identified similar component and geometric constraint relationship, it is determined whether the search object assembly includes the structure of the expanded search source assembly. The result of the determination is output as a search result. In this way, a search can be executed using even a search portion that is not an assembly as a search source, whereby the past design data desired by the user can be more accurately extracted. Accordingly, the past design data can be more effectively utilized.
(iv) In the third embodiment, manufacture or/and design-related data associated with the search source assembly is acquired from the similar structure search database and output together with the search result. Thus, data relating to the past design assembly (related file) can be recycled for the new design assembly.
(v) The present invention may be realized using a software program code for realizing the functions of the embodiments. In this case, a storage medium having the program code recorded therein may be provided to a system or an apparatus, and the program code stored in the storage medium may be read by a computer (or a CPU or an MPU) of the system or the apparatus. In this case, the program code per se read from the storage medium realizes the above-described functions of the embodiments, and the present invention is constituted by the program code per se, or the storage medium having the program code stored therein. Examples of the storage medium for supplying the program code include a flexible disc, a CD-ROM, a DVD-ROM, a hard disk, an optical disk, a magnetooptical disk, a CD-R, magnetic tape, a non-volatile memory card, and a ROM.

Based on the instructions of the program code, an operating system (OS) and the like running on the computer may execute some or all of the actual processes so that the functions of the foregoing embodiments may be realized by the processes. The program code read from the storage medium may be written to a memory in the computer, and, based on the program code instructions, the CPU of the computer and the like may execute some or all of the actual processes so that the functions of the foregoing embodiments may be realized by the processes.

The software program code for realizing the functions of the embodiments may be delivered via a network and stored in a storage means, such as a hard disk or a memory in the system or apparatus, or in a storage medium, such as CD-RW or CD-R. The program code stored in the storage means or the storage medium may be read by the computer (or CPU or MPU) of the system or apparatus and executed when in use.

It should be understood that the processes and technologies described above are not essentially related to any specific apparatus, and may be implemented by any appropriate combination of components. Various general-purpose devices may be used in accordance with the teaching described herein. It may be realized that the method steps described above can be advantageously executed by constructing a dedicated apparatus. Various inventions may be formed by appropriate combinations of a plurality of constituent elements disclosed in the embodiments. For example, some of the constituent elements may be deleted from the entire constituent elements of an embodiment. Constituent elements from different embodiments may be combined as needed. While the present invention has been described with reference to concrete examples, these are for descriptive purposes only and not for limitation in every respect. It will readily occur to those skilled in the relevant field of art that there are a number of appropriate combinations of hardware, software, and firmware for implementing the present invention. For example, the described software may be implemented by a wide range of programs or script languages, such as assembler, C/C++, perl, Shell, PHP, and Java (registered trademark).

In the foregoing embodiments, the control lines or information lines are only those considered necessary for descriptive purposes and do not necessarily represent all of the control lines or information lines required in a product. All of the configurations may be mutually connected.

Other implementations of the present invention will readily occur to those with ordinary knowledge of the relevant technology field from a review of the specification of the present invention and the embodiments disclosed herein. Various modes and/or components of the described embodiments may be used either independently or in any combination in a computerized storage system having a data managing function. The specification and the concrete examples are merely typical, and the scope and spirit of the present invention are indicated by the appended claims

### REFERENCE SIGNS LIST

100 Similar structure search system
110 Computing unit (processor)
111 Similar shape search unit
112 Similar structure search unit
115 CAD_API command unit
120 Similar structure search database
121 Part attribute value
122 Geometric constraint relationship
123 Design/manufacturing information
124 Part similarity
125 Structural similarity/discrepancy degree
130 Input/output unit
131 Search condition input unit
132 Search result display unit
133 Assembly DB registration unit
140 Network
150 3D-CAD system
151 3D-CAD model database
152 CAD_API
153 GUI

1. An assembly model similar structure search system comprising:
a similar structure search database retaining at least a part attribute value indicating an attribute value of a component of an assembly, and information about a geometric constraint relationship indicating a connection relationship between components;
a similar shape search section configured to compare, with reference to the similar structure search database, the part attribute value and the geometric constraint relationship of a search source assembly and a search object assembly which are designated by a user so as to identify, in the search object assembly, a component similar to a constituent component of the search source assembly and a geometric constraint relationship similar to a geometric constraint relationship of the search source assembly;
a similar structure search section, based on information about the similar component and the geometric constraint relationship identified by the similar shape search unit, configured to determine whether the search object assembly includes a structure of the search source assembly; and
an output unit configured to output a result of determination by the similar structure search unit as a search result.

2. The assembly model similar structure search system according to claim 1, wherein:
the search object assembly includes a plurality of sub-assembly portions including the component similar to the constituent component of the search source assembly; and
the similar structure search section is configured to distinguish a first type sub-assembly portion including the search source assembly and a second type sub-assembly portion not including the search source assembly, set the second type sub-assembly portion as a re-search source assembly and the search source assembly as a re-search object assembly, determine whether the re-search source assembly is included in the re-search object assembly, and include a result of the determination in the search result.

3. The assembly model similar structure search system according to claim 2, wherein the similar structure search section is configured to compute similarity between the first type sub-assembly portion and the search source assembly using an eigen value column of the assembly, and include the similarity in the search result.

4. The assembly model similar structure search system according to claim 2, wherein the similar structure search section, when it is determined that the re-search source assembly is not included in the re-search object assembly, is configured to compute a discrepancy degree between the second type sub-assembly and the search source assembly using an eigen value column of the assembly, and includes the discrepancy degree in the search result.

5. The assembly model similar structure search system according to claim 1, wherein:
in the search source assembly, a first type constituent component for which similarity needs to be considered and a second type constituent component for which similarity need not be considered are designated by the user; and
the similar structure search section is configured to determine a structural inclusive relation between the search source assembly and the search object assembly by considering only the first type constituent component.

6. The assembly model similar structure search system according to claim 1, wherein:
the similar shape search section is configured to generate an expanded search source assembly by adding, in accordance with an input node order of expansion, a constituent component of the search source assembly, and compare the part attribute value and the geometric constraint relationship of the expanded search source assembly and the search object assembly so as to identify, in the search object assembly, a component similar to a constituent component of the expanded search source assembly and a geometric constraint relationship similar to a geometric constraint relationship of the expanded search source assembly; and
the similar structure search section, based on information about the similar component and geometric constraint relationship identified by the similar shape search section, is configured to determine whether the search object assembly includes the structure of the expanded search source assembly, and present a result of the determination as the search result.

7. The assembly model similar structure search system according to claim 1, wherein:
the similar structure search database further includes manufacturing or/and design data associated with a plurality of assemblies; and
the output section is configured to acquire from the similar structure search database the manufacturing or/and design data associated with the search source assembly, and output the data together with the search result.

8. An assembly model similar structure search method comprising:
a step of a processor, with reference to a memory retaining at least a part attribute value indicating an attribute value of a component of an assembly and information about a geometric constraint relationship indicating a connection relationship between components, comparing the part attribute value and the geometric constraint relationship between a search source assembly and a search object assembly which are designated by a user;
a step of the processor, based on a result of the comparison, identifying in the search object assembly a component similar to a constituent component of the search source assembly and a geometric constraint relationship similar to a geometric constraint relationship of the search source assembly;
a step of the processor, based on information about the identified similar component and geometric constraint relationship, determining whether the search object assembly includes a structure of the search source assembly; and
a step of the processor outputting a result of the determination as a search result.

9. The assembly model similar structure search method according to claim 8,
wherein:
the search object assembly includes a plurality of sub-assembly portions including a component similar to the constituent component of the search source assembly; and
in the determining step, the processor distinguishes a first type sub-assembly portion including the search source assembly and a second type sub-assembly portion not including the search source assembly, sets the second type sub-assembly portion as a re-search source assembly and the search source assembly as a re-search object assembly, and determines whether the re-search source assembly is included in the re-search object assembly.

10. The assembly model similar structure search method according to claim 8, wherein:
in the search source assembly, a first type constituent component for which similarity needs to be considered and a second type constituent component for which similarity need not be considered are designated by the user; and
in the determining step, the processor determines a structural inclusive relation between the search source assembly and the search object assembly by considering only the first type constituent component.

11. The assembly model similar structure search method according to claim 8, wherein:
in the comparing step, the processor generates an expanded search source assembly by increasing the constituent components of the search source assembly in accordance with an input node order of expansion, and compares the part attribute value and the geometric constraint relationship of the expanded search source assembly and the search object assembly;
in the identifying step, the processor identifies, in the search object assembly, a component similar to the constituent component of the expanded search source assembly and a geometric constraint relationship similar to the geometric constraint relationship of the expanded search source assembly; and
in the determining step, the processor, based on information about the similar component and the geometric constraint relationship identified by the similar shape search section, determines whether the structure of the expanded search source assembly is included.
